(19) United States
(12) Patent Application Publication
(10) Pub. No.: US 2026/0285429 A1
(43) Pub. Date: Sep. 24, 2026

(54) VEHICLE MANUFACTURING SYSTEM AND VEHICLE MANUFACTURING METHOD

(71) Applicant: TOYOTA JIDOSHA KABUSHIKI KAISHA, Toyota-shi (JP)

(72) Inventors: Takeshi KANOU, Seto-shi (JP); Kazuhiko Ueda, Tokyo (JP); Daisuke Kakuma, Numazu-shi (JP); Satoshi Takahashi, Yokohama-shi (JP); Hiroya Chiba, Fuji-shi (JP); Naufal Takbir Ibrahim, Numazu-shi (JP); Sen Yang, Susono-shi (JP)

(73) Assignee: TOYOTA JIDOSHA KABUSHIKI KAISHA, Toyota-shi (JP)

(21) Appl. No.: 19/536,506

(22) Filed: Feb. 11, 2026

(30) Foreign Application Priority Data
Mar. 21, 2025 (JP) 2025-046589

(51) Int. Cl. B62D 65/18; G05D 1/617; G05D 1/695; G05D 107/70

(52) U.S. Cl. CPC B62D 65/18; G05D 1/617; G05D 1/695; G05D 2107/70

(57) ABSTRACT

A vehicle manufacturing system that controls a plurality of vehicles to travel in a formation during a manufacturing process or a transport process includes: detecting an abnormal vehicle in which an abnormality has occurred among the vehicles; stopping the abnormal vehicle; and causing a subsequent vehicle that travels behind the abnormal vehicle to travel so as to bypass the abnormal vehicle that is stopped.

### CROSS-REFERENCE TO RELATED APPLICATION

This application claims priority to Japanese Patent Application No. 2025-046589 filed on March 21, 2025. The disclosure of the above-identified application, including the specification, drawings, and claims, is incorporated by reference herein in its entirety.

### BACKGROUND

### 1. Technical Field

The present disclosure relates to a vehicle manufacturing system and a vehicle manufacturing method.

### 2. Description of Related Art

Japanese Patent No. 7424535 (JP 7424535 B) discloses a remote control device that remotely controls a moving object. The remote control device acquires three-dimensional point cloud data measured by a distance measurement device. The remote control device estimates a position and an orientation of the moving object by matching a template point cloud indicating the moving object with the three-dimensional point cloud data.

### SUMMARY

In a vehicle manufacturing plant, a plurality of vehicles travels along a transport route and are manufactured in order. Therefore, it is possible to improve productivity. Meanwhile, it is desirable to appropriately control the vehicles traveling along the transport route.

Therefore, an object of the present disclosure is to provide a vehicle manufacturing system and a vehicle manufacturing method that are capable of appropriately controlling a vehicle.

A vehicle manufacturing system according to the present disclosure is a vehicle manufacturing system that controls, during a manufacturing process or during a transport process, a plurality of vehicles such that the vehicles travel in a formation. The vehicle manufacturing system is configured to

detect, among the vehicles, an abnormal vehicle in which an abnormality has occurred; stop the abnormal vehicle; and

cause a subsequent vehicle that travels behind the abnormal vehicle to travel such that the subsequent vehicle bypasses the abnormal vehicle that is not moving.

A vehicle manufacturing method according to the present disclosure is a vehicle manufacturing method of controlling, during a manufacturing process or during a transport process, a plurality of vehicles such that the vehicles travel in a formation. The vehicle manufacturing method includes:

detecting, among the vehicles, an abnormal vehicle in which an abnormality has occurred;

stopping the abnormal vehicle; and

causing a subsequent vehicle that travels behind the abnormal vehicle to travel such that the subsequent vehicle bypasses the abnormal vehicle that is not moving.

According to the present disclosure, it is possible to provide a vehicle manufacturing system and a vehicle manufacturing method that are capable of appropriately controlling a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing an overall configuration of a vehicle manufacturing system;

FIG. 2 is a schematic diagram showing a part of the vehicle manufacturing system;

FIG. 3 is a block diagram showing a control system of the vehicle manufacturing system;

FIG. 4 is a diagram showing an example of a route change;

FIG. 5 is a diagram showing an example of the route change;

FIG. 6 is a flowchart showing a method using the vehicle manufacturing system;

FIG. 7 is a diagram for describing traveling control of a vehicle;

FIG. 8 is a control block diagram for describing a traveling control example 1;

FIG. 9 is a flowchart for describing the traveling control example 1;

FIG. 10 is a control block diagram for describing a traveling control example 2; and

FIG. 11 is a flowchart for describing the traveling control example 2.

### DETAILED DESCRIPTION OF EMBODIMENTS

Hereinafter, embodiments of the present disclosure will be described with reference to the drawings. However, the disclosure according to the claims is not limited to the following embodiments. In addition, all of the configurations described in the embodiment are not always needed as means for solving the problem. In order to clarify the description, the following description and drawings are omitted and simplified as appropriate. In drawings, the same elements are designated by the same reference numerals, and repeated descriptions thereof are omitted as necessary.

### Vehicle Manufacturing System

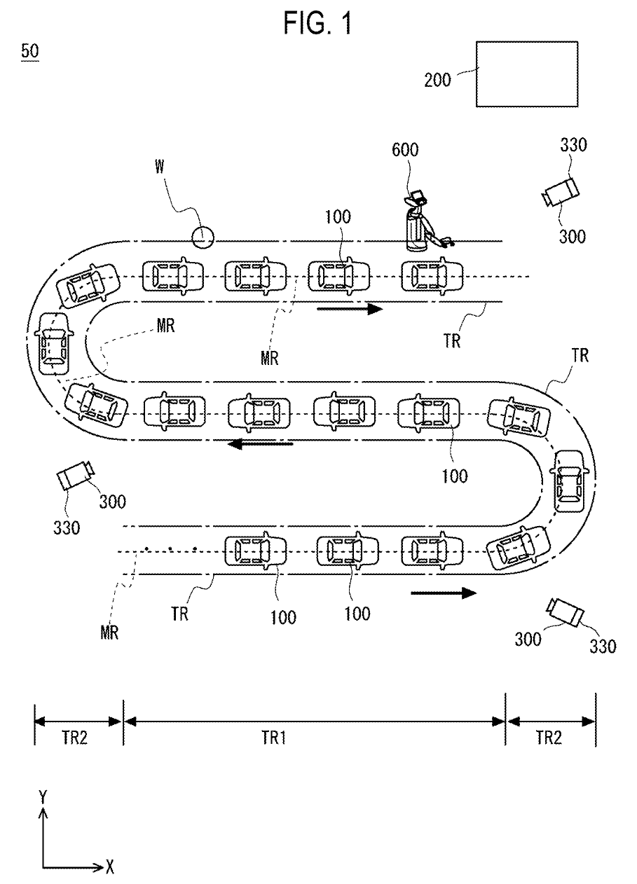

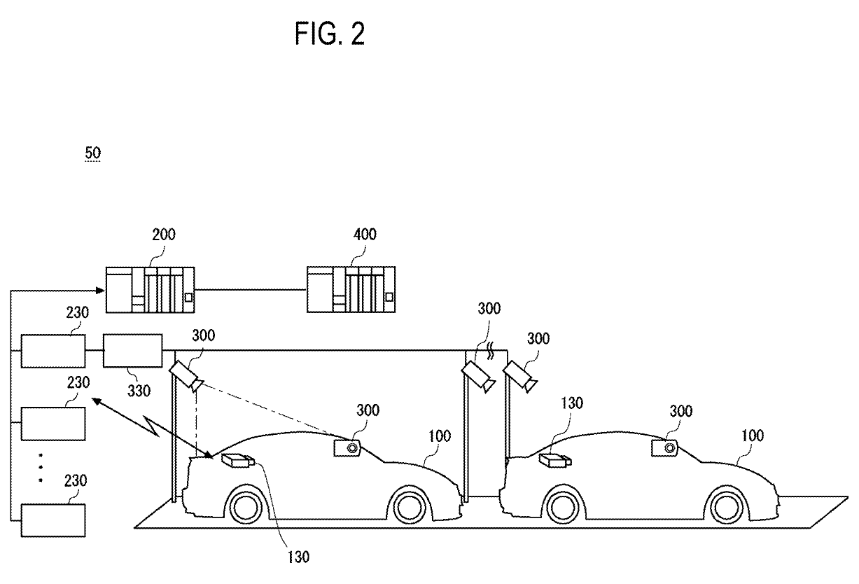

A vehicle manufacturing system 50 according to the present embodiment will be described with reference to FIGS. 1 and 2. FIG. 1 is a schematic diagram showing a configuration of the vehicle manufacturing system 50. FIG. 2 is a diagram schematically showing two vehicles 100 during traveling. In FIG. 1, an XY orthogonal coordinate system is shown for description.

The vehicle manufacturing system (referred to as a system) 50 is used in a vehicle manufacturing plant that manufactures the vehicle 100. Alternatively, the vehicle manufacturing system 50 is also used in a transport location where a transport process such as transport to a yard or loading onto a ship is performed. As shown in FIG. 1, the vehicle manufacturing system 50 includes a server 200, a sensor 300, and a robot 600. The vehicles 100 are autonomous driving vehicles that can travel on their own during the manufacturing process. The vehicle manufacturing system 50 performs control such that the vehicles 100 travel in a formation.

The sensor 300 includes a communication device 330 that transmits and receives data to and from the server 200. The server 200 includes a communication device 230 that transmits and receives data to and from the sensor 300. Further, as shown in FIG. 2, the communication device 230 has a function of transmitting and receiving data to and from the vehicle 100. In addition, the vehicle 100 includes a communication device 130 that receives data from the server 200. Each of the vehicles 100 includes the communication device 130.

The communication device 130, the communication device 230, and the communication device 330 may be general-purpose devices such as a network hub or a router device. The communication device 130, the communication device 230, and the communication device 330 use, for example, general-purpose wireless communication such as Wi-Fi (registered trademark). An address for specifying a communication partner is set in each of the communication device 130, the communication device 230, and the communication device 330. The communication address is, for example, an Internet Protocol (IP) address.

Each of the vehicles 100 is a vehicle before completion. As shown in FIG. 1, the vehicle 100 travels along a predetermined track TR. As the vehicle 100 travels along the track TR, the vehicle 100 is manufactured. Specifically, a worker W, the robot 600, or the like assembles a component, operates a switch, performs welding, performs an inspection, or the like during traveling of the vehicle 100 on the track. As a result, work of each manufacturing process is performed. Then, the vehicle 100 is manufactured by performing the work of each manufacturing process in a predetermined order.

The vehicles 100 travel in a formation. Specifically, the vehicle 100 travels at a constant speed such that the vehicle distance is constant at a predetermined distance. Further, the vehicles 100 have the same speed. In addition, the track TR includes a straight traveling region TR1 in which the vehicle 100 travels straight and a turning region TR2 in which the vehicle 100 turns. In the straight traveling region TR1, the track TR is linear.

The turning region TR2 is a location where the vehicle 100 changes direction. In the turning region TR2, the vehicle 100 performs a U-turn. In the turning region TR2, for example, the track TR has an arc shape having a predetermined curvature radius. In the turning region TR2, the track TR is a semicircle. The turning region TR2 is provided at both ends of the straight traveling region TR1. For example, in a case where the vehicle 100 travels in the +X direction in the straight traveling region TR1, the vehicle 100 reaches the turning region TR2. In a case where the vehicle 100 turns 180 degrees in the turning region TR2, the vehicle 100 travels in the -X direction in the straight traveling region TR1. On the contrary, in a case where the vehicle 100 travels in the -X direction in the straight traveling region TR1, the vehicle 100 reaches the turning region TR2. In a case where the vehicle 100 turns 180 degrees in the turning region TR2, the vehicle 100 travels in the +X direction in the straight traveling region TR1. In this way, the vehicle 100 is manufactured in order by alternately passing through the straight traveling region TR1 and the turning region TR2.

The sensor 300 is a camera that images the vehicle 100 during traveling or stopping. The sensor 300 images one or a plurality of vehicles 100. The sensor 300 is provided to detect an inter-vehicle distance or the like. The server 200 can detect the position of the vehicle 100 in the factory based on the image captured by the sensor 300. For example, the sensor 300 is installed on a wall surface, a support column, a ceiling, or the like of the factory and images the vehicle 100 from an oblique upward direction. The sensor 300 images the vehicle 100 in a formation with an angle of view including one or more vehicles 100 in the formation. The sensor 300 may be set to the same height as the vehicle 100 and may image one or more vehicles 100 from the side.

The communication device 330 transmits the captured image captured by the sensor 300 to the server 200. The communication device 330 may transmit information obtained from the captured image to the server 200, in addition to the captured image. That is, the communication device 330 transmits the detection result detected by the sensor 300. The communication device 330 may be built in the sensor 300 or may be separate from the sensor 300. In addition, the communication device 330 may be shared by a plurality of the sensors 300. That is, in a case where a plurality of the sensors 300 are installed, one communication device 330 may transmit the data to the server 200.

In this way, in a case where the sensor 300 images the vehicle 100, the communication device 330 transmits the captured image and the like to the server 200. The communication device 230 receives the data of the captured image from the sensor 300. The server 200 can estimate the inter-vehicle distance by performing predetermined image processing on the captured image of the sensor 300. For example, the server 200 calculates the inter-vehicle distance or the like in the vehicles 100 in the formation. The number of vehicles in the formation is not particularly limited, and may be two or more.

In addition, the sensor 300 is not limited to the camera. The sensor for detecting the inter-vehicle distance may be various sensors such as an RGB camera, a far-infrared camera, and a LiDAR. The sensor 300 is not limited to an optical sensor and may be a radar. Of course, two or more sensors 300 may be installed, or two or more types of sensors 300 may be used in combination. For example, the sensor 300 may include a LiDAR and a camera.

The communication device 330 transmits the detection result to the server 200. As described above, the detection result transmitted by the sensor 300 may be the captured image or information extracted from the image. For example, in a case where the sensor 300 has an image processing function, the sensor 300 transmits the information extracted by the image processing to the server 200.

In addition, as shown in FIG. 2, the sensor 300 may be mounted on the vehicle 100. For example, an in-vehicle camera, a LiDAR, a radar, or the like is the sensor 300. In a case where the sensor 300 is an in-vehicle camera, the sensor 300 images the vehicle 100 in front. In a case where the sensor 300 is an in-vehicle LiDAR, the sensor 300 measures a distance to the vehicle 100 in front. The communication device 130 transmits the image or the measurement result to the server 200.

The server 200 controls the vehicle 100 such that the vehicle 100 moves along the track TR. Further, the server 200 controls the vehicles 100 such that the vehicles 100 travel in a formation. For example, the vehicle 100 travels in a single row along the track TR. The server 200 transmits the control signal to each of the vehicles 100 via the communication device 230.

The server 200 is not limited to a single device and may be configured by a plurality of devices. For example, the server 200 may have a plurality of arithmetic processing devices that perform distributed processing. Alternatively, the server 200 may have a storage device, a communication device, a display device, an interface device, an input device, or the like, separately from the device that performs the arithmetic processing.

As shown in FIG. 1, the track TR indicates a region in which the vehicle 100 is scheduled to travel. For example, in the width direction of the vehicle 100, the size is the total width of the vehicle 100 plus a margin. For example, the track TR may be a virtual track registered on map information of a facility. Alternatively, the line shown in the track TR may be provided on a road surface. The track TR may be defined by a wall surface or the like.

The vehicle 100 travels to a destination along a movement route MR in the track TR. The movement route MR is set in the track TR such that the vehicle 100 does not protrude from the track TR. The movement route MR is set near the center of the track TR in the width direction. The vehicle 100 passes on the movement route MR. The destination is a location where each manufacturing process is performed. In other words, the destination is set in the middle of the track TR. Then, the vehicle 100 moves to a plurality of destinations set in the track TR in order. The movement route MR is a line connecting the destination (waypoint).

In FIG. 1, only one track TR is shown, but the track TR may be branched in the middle. Alternatively, two tracks TR may be merged. For example, a part of the track may be different for each vehicle type. Here, the vehicle 100 is a moving object that can travel without a driver. For example, the vehicle 100 may travel in a state where a driving vehicle is not boarded. Alternatively, in at least a part of the track TR, the vehicle 100 may be remotely controlled by a manager, a worker, or the like by wireless communication or the like. The vehicle 100 is not limited to an automobile and may be a moving object such as a traveling robot or a flying car. Therefore, the system 50 can also be referred to as a control system that controls a moving object such as a vehicle.

The server 200 manages ID information or a traveling location of the vehicle 100. For example, communication is performed between the server 200 and the vehicle 100 based on the IP addresses of the communication device 230 and the communication device 130. Specifically, the server 200 designates the IP address of the vehicle 100 that has transmitted the signal to perform the transmission processing. The traveling location or the traveling order of the vehicle 100 is specified based on the captured image of the sensor 300.

The server 200 performs control such that the vehicles 100 move along the movement route MR. Specifically, the server 200 performs control such that the vehicle 100 travels following the vehicle 100 in front. For example, the vehicles 100 perform formation traveling such that the inter-vehicle distance to the vehicle 100 in front is constant.

Further, in a case where an abnormality occurs in the vehicle 100, the server 200 sets a bypass route. The subsequent vehicle of the vehicle 100 in which the abnormality has occurred travels along the bypass route. As a result, the subsequent vehicle can travel while avoiding the abnormal vehicle. Since the subsequent vehicle can travel to the destination, productivity can be improved.

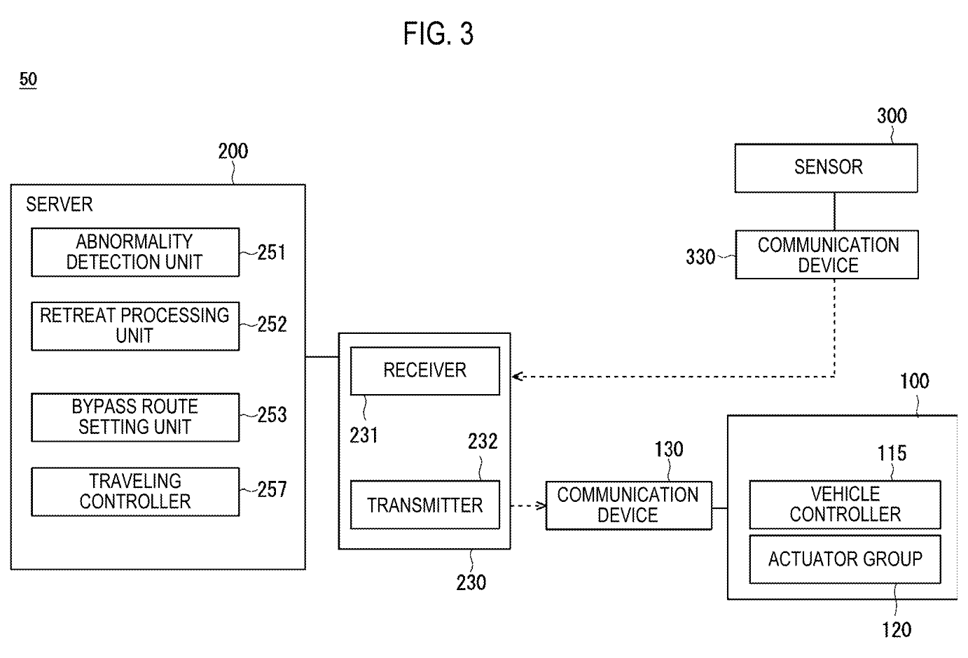

Hereinafter, the control system of the system 50 will be described with reference to FIG. 3. FIG. 3 is a block diagram showing the control system of the system 50.

The server 200 includes the communication device 230, an abnormality detection unit 251, a retreat processing unit 252, a bypass route setting unit 253, and a traveling controller 257. The server 200 functions as a moving object control device that controls the traveling of the vehicles 100. In FIG. 3, only one vehicle 100 and one sensor 300 are shown, but as shown in FIGS. 1 and 2, a plurality of the vehicles 100 and the sensors 300 are provided.

The communication device 230 includes a receiver 231 and a transmitter 232. The receiver 231 receives various signals, data, and the like from the sensor 300 and the vehicle 100. For example, the receiver 231 receives data indicating the detection result in the sensor 300. The data received from the sensor 300 may be image data or data extracted from the image data.

The transmitter 232 transmits various signals, data, and the like to the sensor 300 and the vehicle 100. For example, the transmitter 232 transmits a control instruction value to the vehicle 100. Of course, the server 200 may transmit and receive data other than the above. As communication in the receiver 231 and the transmitter 232, processing according to a general communication standard such as Wi-Fi (registered trademark) can be used.

The vehicle 100 includes a vehicle controller 115, an actuator group 120, and a communication device 130. The sensor 300 includes the communication device 130. The server 200 is not limited to a single physical device and may be distributed and disposed. For example, the database may be a storage device, a cloud server, or the like provided separately from the processor.

The communication device 130 of the vehicle 100 is a wireless terminal device for performing wireless communication with the server 200. An Internet Protocol (IP) address or the like is set in the communication device 130. In a case where the communication device 130 of the vehicle 100 receives the control instruction value, the vehicle 100 moves in response to the control instruction value. The actuator group 120 includes a wheel motor for driving a wheel, a steering motor for controlling a steering angle, a brake for stopping the vehicle, and the like. The vehicle controller 115 generates a control signal to control the actuator group 120 in response to the control instruction value. The vehicle controller 115 may be configured by an electronic control unit (ECU). As a result, the vehicle 100 can move along the track TR.

In the following description, the server 200 will be described as performing image processing or the like on the captured image acquired from the sensor 300, but the processing may be performed by a device other than the server 200. For example, the sensor 300 may perform a part of the processing. Specifically, the sensor 300 may extract a feature amount necessary for the image processing and transmit the feature amount to the server 200. Alternatively, a processor such as a graphics processing unit (GPU) provided in the sensor 300 may recognize the blinking pattern and transmit the recognition result.

As described above, the sensor 300 transmits the captured image to the server 200. The captured image may be a video or a series of still images. The communication device 230 of the server 200 receives the captured image. The server 200 acquires a frame and an imaging time of the frame and records the frame and the imaging time in a memory or the like. The sensor 300 captures an image at, for example, a frame rate of 30fps or 60fps. The server 200 specifies the current position of each of the vehicles 100 based on the captured image or the like in the sensor 300. Alternatively, the server 200 may specify the current position of the vehicle 100 based on a detection result of the LiDAR or the like.

The traveling controller 257 generates, for example, a traveling control signal for causing the vehicle 100 to steer, stop, temporarily stop, emergency stop, decelerate, accelerate, start, or the like. In a case where the traveling controller 257 outputs the traveling control signal to the transmitter 232, the transmitter 232 transmits the traveling control signal to the vehicle 100. As a result, the vehicle 100 steers, stops, temporarily stops, emergency stops, decelerates, accelerates, or starts. That is, the vehicle controller 115 controls the actuator group 120. The brake, the wheel motor, the steering motor, and the like of the actuator group 120 operate such that the vehicle 100 accelerates, decelerates, starts, turns right, turns left, or the like.

The position of the sensor 300 in the facility is known. In this case, the server 200 can detect the position for each of the vehicles 100 based on the captured image of the sensor 300. The traveling controller 257 can control the traveling speed, the steering angle, and the like based on the position of the vehicle 100. Alternatively, the traveling controller 257 may control the traveling speed or the steering angle in accordance with the traveling order in the formation.

The traveling controller 257 generates a traveling control signal indicating a control instruction value for the steering angle or the speed. The traveling controller 257 calculates the control instruction value of each of the vehicles at a predetermined time interval. Then, in a case where the traveling controller 257 generates the traveling control signal indicating the control instruction value, the transmitter 232 transmits the traveling control signal to the corresponding vehicle 100. In a case where the communication device 130 of the vehicle 100 receives the traveling control signal, the vehicle controller 115 controls the actuator group 120 to be the control instruction value. In this way, the vehicle 100 can move to the destination along the movement route MR in the track TR.

Further, the traveling controller 257 controls the traveling of the vehicle 100 in which the abnormality has occurred and the subsequent vehicle in a case where the abnormality of the vehicle 100 is detected. Hereinafter, processing in a case of detecting the abnormality will be described.

The abnormality detection unit 251 detects the abnormality of the vehicle 100. For example, the abnormality detection unit 251 can detect the abnormality based on the captured image or the like from the sensor 300. Specifically, in a case where the abnormality occurs in the device of the vehicle 100, the vehicle 100 performs an operation indicating that the abnormality has occurred. Examples of the operation indicating that the abnormality has occurred include blinking of a light. The sensor 300 images the vehicle in which the light blinks in a predetermined pattern. The abnormality detection unit 251 can detect the abnormality by performing image processing or the like. Hereinafter, the vehicle in which the abnormality has occurred is referred to as an abnormal vehicle.

Alternatively, the abnormality detection unit 251 may detect the abnormality by receiving an abnormal signal from the abnormal vehicle, a vehicle around the abnormal vehicle, or the like. For example, in a case where a failure occurs in the device mounted on the vehicle 100, the vehicle 100 transmits the abnormal signal to the server 200. The abnormal signal is a signal indicating that the abnormality has occurred. For example, the abnormal signal may include ID information of the vehicle in which the abnormality has occurred, a type of the abnormality, information indicating the failed device, and the like. Alternatively, the vehicle 100 may transmit a normal signal indicating that the vehicle 100 is normal at regular intervals. Then, in a case where the server 200 cannot receive the normal signal for a certain time or longer, the abnormality detection unit 251 detects that the abnormality has occurred in the vehicle 100. Alternatively, a worker or the like may be notified of the occurrence of the abnormality.

The server 200 detects the abnormality of the vehicle 100 or the like based on various signals and the like. The abnormality detection unit 251 can specify the ID information of the abnormal vehicle, the abnormality occurrence location, the position of the abnormal vehicle, the type of the abnormality, the failed device, and the like.

The retreat processing unit 252 performs processing for retreating the abnormal vehicle. The retreat processing indicates processing of moving the abnormal vehicle to a position outside the movement route MR. Specifically, the retreat processing unit 252 determines whether the abnormal vehicle can continue to travel. The retreat processing unit 252 determines whether the abnormal vehicle can travel based on information such as the type of the abnormality in the abnormal vehicle and the failed device. Further, the retreat processing unit 252 determines whether there is a retreat location around the abnormal vehicle.

For example, in a case where the brake, the steering motor, the wheel motor, or the like fails, the abnormality is a serious abnormality, and thus the abnormal vehicle cannot travel. In addition, in a case where the light, the sensor, the communication device 130, or the like fails, the abnormality is a mild abnormality, and thus the abnormal vehicle can travel. Even in a case where the device fails, the retreat processing unit 252 determines that the abnormal vehicle can travel to the retreat location in a case where there is no problem in traveling or in a case where the influence on the traveling control is small.

In a case where the abnormal vehicle can travel, the retreat processing unit 252 moves the abnormal vehicle to the retreat location near the abnormal vehicle. Then, the retreat processing unit 252 stops the abnormal vehicle after the abnormal vehicle is moved to the retreat location. The retreat location is a location that does not interfere with other vehicles 100, a worker, or the like. In a case where the abnormal vehicle cannot travel, the retreat processing unit 252 stops the abnormal vehicle on the movement route MR without performing the retreat processing. Alternatively, in a case where there is no retreat location, the retreat processing unit 252 stops the abnormal vehicle on the movement route MR without performing the retreat processing.

The retreat location may be set in advance on the map. Alternatively, the retreat processing unit 252 may acquire the retreat location or the stop position of the abnormal vehicle in accordance with the detection result in the sensor 300. For example, in a case where a vacant space in which the vehicle 100 can stop is detected, the location may be set as the retreat location. Alternatively, the retreat location or the stop position may be set in a portion of the track TR where the width of the track TR is not narrowed. As described above, the retreat processing unit 252 may determine whether to perform the retreat processing based on the detection result in the sensor 300.

The bypass route setting unit 253 sets the bypass route for the subsequent vehicle. The subsequent vehicle is the vehicle 100 that travels behind the abnormal vehicle. The bypass route setting unit 253 sets the bypass route such that the subsequent vehicle does not come into contact with the abnormal vehicle.

For example, the bypass route is a route for traveling on one side of the abnormal vehicle in the left-right direction. The bypass route is a route that deviates to the left or right side of the movement route. Then, the bypass route is set such that the subsequent vehicle returns to the original movement route MR after passing the abnormal vehicle. That is, the bypass route is a route that branches from the movement route MR and then rejoins the movement route MR again.

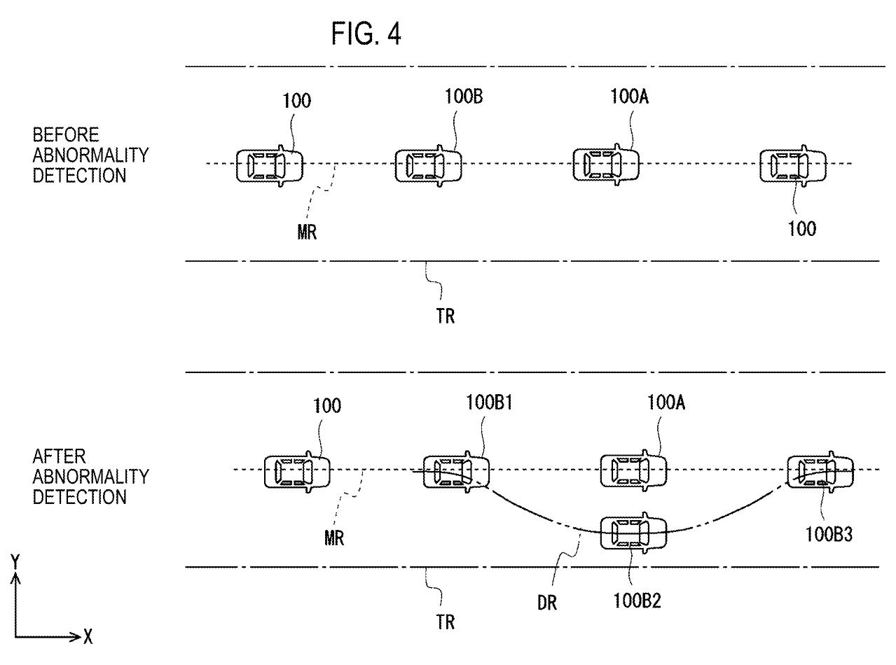

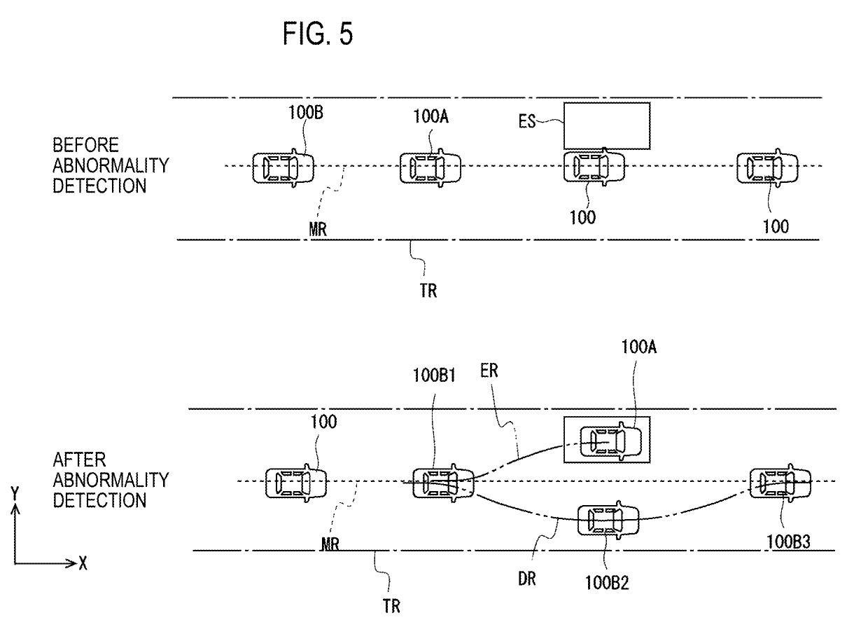

The bypass route will be described with reference to FIGS. 4 and 5. FIGS. 4 and 5 are top views showing an example of the bypass route. FIG. 4 shows a case where the abnormal vehicle 100A is not moved to the retreat location. That is, FIG. 4 shows a bypass route DR in a case where the abnormal vehicle 100A stops on the movement route MR. FIG. 5 shows a bypass route DR in a case where the abnormal vehicle 100A is retreated to a retreat location ES deviated from the movement route MR. Further, in FIGS. 4 and 5, the abnormal vehicle 100A and the subsequent vehicle 100B before the abnormality detection are shown. Further, in FIGS. 4 and 5, the trajectories of the subsequent vehicle 100B after the abnormality detection are shown as subsequent vehicles 100B1 to 100B3. Here, an example will be described in which the vehicles 100 travel in a formation in the +X direction along the linear movement route MR.

First, a case where the abnormal vehicle 100A cannot travel and cannot move to the retreat location will be described with reference to FIG. 4. As shown before the abnormality detection in FIG. 4, the subsequent vehicle 100B travels after the abnormal vehicle 100A. That is, before the abnormality detection, the abnormal vehicle 100A and the subsequent vehicle 100B travel on the movement route MR. The subsequent vehicle 100B is a vehicle that travels immediately after the abnormal vehicle 100A, and after the abnormality detection, the subsequent vehicles 100B1, 100B2, 100B3 travel in this order.

In a case where the abnormality detection unit 251 detects the abnormality of the abnormal vehicle 100A, the abnormal vehicle 100A quickly stops. That is, the abnormal vehicle 100A stops on the movement route MR. Then, the bypass route setting unit 253 sets the bypass route DR to bypass the abnormal vehicle 100A. Therefore, the subsequent vehicle 100B moves in the order of the subsequent vehicles 100B1, 100B2, 100B3. That is, after the abnormality detection, the movement trajectory of the subsequent vehicle 100B is in the order of the subsequent vehicle 100B1, the subsequent vehicle 100B2, and the subsequent vehicle 100B3.

The bypass route setting unit 253 sets the bypass route DR based on the stop position of the abnormal vehicle 100A, the abnormality occurrence location, or the like. At the position of the subsequent vehicle 100B1, the bypass route DR branches from the movement route MR. The position of the subsequent vehicle 100B2 deviates to the right side of the stop position of the abnormal vehicle 100A. Then, at the position of the subsequent vehicle 100B3, the bypass route DR and the movement route MR are merged. After the bypass route DR is merged with the movement route MR, the subsequent vehicle 100B3 travels along the movement route MR. At a position on the -X side of the stop position of the abnormal vehicle 100A, the bypass route DR is a branch route that branches to the right side from the movement route MR. Further, the bypass route DR is merged with the movement route MR at a position on the +X side of the stop position of the abnormal vehicle 100A.

As described above, the bypass route setting unit 253 sets the bypass route that bypasses the abnormal vehicle 100A and then merges with the movement route MR. For example, the subsequent vehicle 100B proceeds to the right side to deviate from the movement route MR and then proceeds to the left side to return to the movement route MR. In this way, the subsequent vehicle 100B can travel along the movement route MR again after avoiding the abnormal vehicle 100A. Therefore, even after the abnormal vehicle 100A stops, the subsequent vehicle 100B can arrive at the waypoint or the destination. Therefore, since each production process can be performed on the subsequent vehicle 100B, productivity can be improved.

The bypass route setting unit 253 sets the bypass route based on the stop position of the abnormal vehicle 100A. In FIG. 4, the bypass route DR is generated on the right side of the movement route MR, but may be generated on the left side of the movement route MR. That is, the subsequent vehicle 100B may pass through any one of the left or right side of the abnormal vehicle 100A.

Next, a case where the abnormal vehicle 100A can travel and moves to the retreat location after the abnormality detection will be described with reference to FIG. 5. As shown before the abnormality detection in FIG. 5, the subsequent vehicle 100B travels after the abnormal vehicle 100A. That is, before the abnormality detection, the abnormal vehicle 100A and the subsequent vehicle 100B travel on the movement route MR. The subsequent vehicle 100B is a vehicle that travels immediately after the abnormal vehicle 100A, and after the abnormality detection, the subsequent vehicles 100B1,100B2, 100B3 travel in this order.

In a case where the abnormality detection unit 251 detects the abnormality of the abnormal vehicle 100A, the abnormal vehicle 100A moves to the retreat location ES. That is, the abnormal vehicle 100A moves along a retreat route ER from the abnormality occurrence location to the retreat location ES. Here, the abnormality detection unit 251 may set the retreat route ER to the retreat location ES. The retreat route ER is a branch route that branches to the left side from the movement route MR. As a result, the abnormal vehicle 100A stops at a position deviated from the movement route MR.

The bypass route setting unit 253 sets the bypass route DR to bypass the abnormal vehicle 100A at the retreat location ES. Therefore, the subsequent vehicle 100B moves in the order of the subsequent vehicles 100B1, 100B2, 100B3. That is, after the abnormality detection, the movement trajectory of the subsequent vehicle 100B is in the order of the subsequent vehicle 100B1, the subsequent vehicle 100B2, and the subsequent vehicle 100B3.

The bypass route setting unit 253 sets the bypass route DR based on the retreat location ES of the abnormal vehicle 100A or the like. At the position of the subsequent vehicle 100B1, the bypass route DR branches from the movement route MR. The position of the subsequent vehicle 100B2 deviates to the right side of the stop position of the abnormal vehicle 100A. Then, at the position of the subsequent vehicle 100B3, the bypass route DR and the movement route MR are merged. After the bypass route DR is merged with the movement route MR, the subsequent vehicle 100B3 travels along the movement route MR. At a position on the -X side of the retreat location ES, the bypass route DR is a branch route that branches to the right side from the movement route MR. Further, the bypass route DR is merged with the movement route MR at a position on the +X side of the retreat location ES.

As described above, the bypass route setting unit 253 sets the bypass route that bypasses the abnormal vehicle 100A and then merges with the movement route MR. The subsequent vehicle 100B proceeds to the right side to deviate from the movement route MR and then proceeds to the left side to return to the movement route MR. In this way, the subsequent vehicle 100B can travel along the movement route MR again after avoiding the abnormal vehicle 100A. Therefore, even after the abnormal vehicle 100A stops, the subsequent vehicle 100B can arrive at the waypoint or the destination. Therefore, since each production process can be performed on the subsequent vehicle 100B, productivity can be improved.

The abnormal vehicle 100A retreats to deviate in the left-right direction from the movement route MR and then stops. The subsequent vehicle 100B travels to bypass the abnormal vehicle 100A on a side opposite to the retreat direction in which the abnormal vehicle 100A retreats in the left-right direction. In this way, since the distance of the bypass route DR can be shortened, productivity can be improved. For example, the bypass route DR in FIG. 5 deviates to the right side by a smaller amount than the bypass route DR in FIG. 4. Therefore, since the bypass route DR can be shortened, the vehicle can travel efficiently. In FIG. 5, the abnormal vehicle 100A retreats in the left direction, but may retreat in the right direction. In this case, the subsequent vehicle 100B travels to bypass the abnormal vehicle 100A in the left direction.

The bypass route setting unit 253 can set the bypass route based on the retreat location ES of the abnormal vehicle 100A. That is, the bypass route setting unit 253 sets the bypass route such that the subsequent vehicle does not come into contact with the abnormal vehicle. For example, the retreat position is set at a position in the left-right direction with respect to the vehicle 100 from the movement route. The bypass route is a route that deviates in a direction opposite to the stop position in the left-right direction.

The bypass route DR is generated on the right side of the retreat location ES, but may be generated on the left side of the retreat location ES. For example, the bypass route setting unit 253 sets the bypass route DR on a side opposite to the retreat location ES in the left-right direction. Specifically, in a case where the retreat location ES is on the right side of the movement route MR, the bypass route DR may be on the left side of the movement route MR. In a case where the retreat location ES is on the left side of the movement route MR, the bypass route DR may be on the right side of the movement route MR.

The server 200 can perform control such that the subsequent vehicle travels appropriately. For example, it is possible to prevent the subsequent vehicle from coming into contact with the abnormal vehicle 100A. Further, the subsequent vehicle bypasses the stop position of the abnormal vehicle 100A on the movement route MR and then returns to the movement route MR again. That is, the subsequent vehicle travels only at a position that deviates from the movement route MR at the stop position of the abnormal vehicle 100A and around the stop position. Therefore, even in a case where the abnormal vehicle 100A is stopped, the influence on the formation traveling can be suppressed. Here, the bypass route DR is generated on the right side of the abnormal vehicle 100A, but may be generated on the left side of the abnormal vehicle 100A.

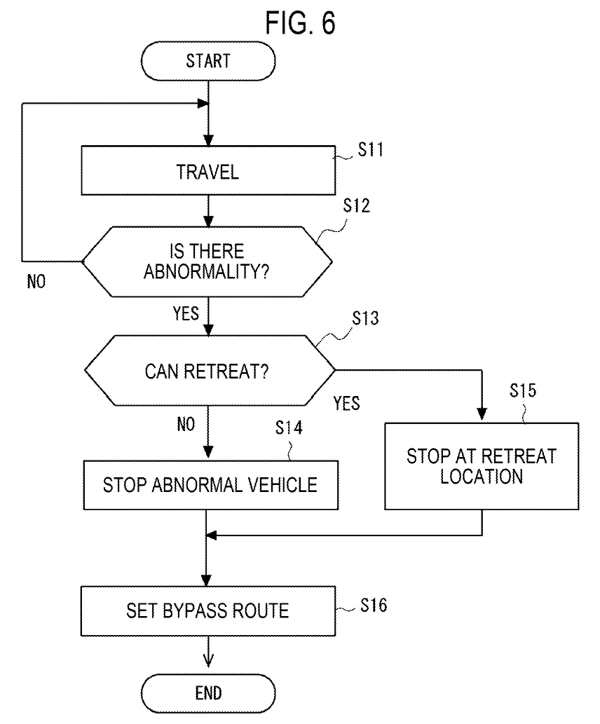

A vehicle manufacturing method by the vehicle manufacturing system 50 will be described with reference to FIG. 6. FIG. 6 is a flowchart showing a control method. First, the server 200 or the like causes the vehicles 100 to travel (S11). Here, as shown in FIGS. 1, 4 and 5, the vehicles 100 travel in a formation along the movement route MR. The abnormality detection unit 251 determines whether there is an abnormality in the vehicle 100 (S12). In a case where the abnormality has not occurred (NO in S12), the vehicles 100 continue to travel along the movement route MR (S11).

In a case where the abnormality has occurred (YES in S12), the retreat processing unit 252 determines whether the abnormal vehicle can retreat (S13). For example, the retreat processing unit 252 determines whether the abnormal vehicle can continue to travel. Alternatively, the retreat processing unit 252 determines whether there is a retreat location near the abnormal vehicle. In a case where the abnormal vehicle cannot be retreated (NO in S13), the traveling controller 257 stops the abnormal vehicle (S14). Here, the abnormal vehicle quickly stops on the movement route MR.

In a case where the abnormal vehicle can be retreated (YES in S13), the retreat processing unit 252 and the traveling controller 257 stop the abnormal vehicle at the retreat location (S15). Here, the abnormal vehicle moves to the retreat location and then stops.

Then, in a case where the abnormal vehicle is stopped, the bypass route setting unit 253 sets the bypass route for the subsequent vehicle (S16). As a result, the subsequent vehicle can bypass the abnormal vehicle that is not moving. Therefore, the manufacturing process of the vehicle can be performed on the subsequent vehicle. Therefore, productivity can be improved.

A part of the steps may be executed in parallel. For example, at least a part of the processing for setting the bypass route may be set while the processing of stopping the abnormal vehicle in S14 or the processing of stopping at the retreat location in S15 is being performed. For example, the bypass route setting unit 253 may set the bypass route while the subsequent vehicle is moving to the retreat location. In this case, the bypass route can be set according to the retreat location.

In the above description, the server 200 mainly controls the vehicle 100, but another device may perform the control. The vehicle 100 and the server 200 may cooperate to perform the control. That is, the server 200 and the vehicle 100 may cooperate to function as the bypass route setting unit that sets the bypass route of the vehicle.

In addition, the vehicle 100 may perform a part of the processing of the server 200. In this case, the vehicle 100 may set the bypass route according to the stop position of the vehicle 100 in front. Alternatively, the abnormal vehicle may perform the retreat processing.

In addition, the bypass route setting unit may not set the bypass route. For example, the subsequent vehicle is an autonomous moving object that is capable of autonomous driving by using a sensor such as a LiDAR. The subsequent vehicle switches to autonomous driving to bypass the abnormal vehicle. The subsequent vehicle performs autonomous driving by treating the abnormal vehicle that is not moving as an obstacle. The subsequent vehicle bypasses the abnormal vehicle via autonomous driving.

Hereinafter, a traveling control example for controlling the traveling of the vehicle 100 in the system will be described.

### A. Traveling Control Example 1

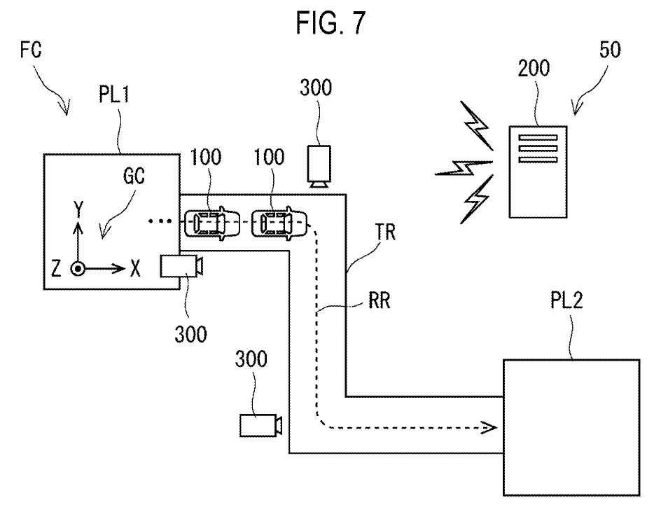

FIG. 7 is a conceptual diagram showing a configuration of the system 50 in the traveling control example 1. The system 50 includes the vehicles 100 as the moving object, the server 200, and one or more sensors 300.

In addition, in a case where the moving object is other than a vehicle, the expression of "vehicle" and "car" in the present disclosure can be replaced with "moving object" as appropriate, and the expression of "travel" can be replaced with "move" as appropriate.

The vehicle 100 is configured to travel via unmanned driving. The "unmanned driving" means driving that does not depend on a traveling operation of an occupant. The traveling operation means an operation related to at least any one of "traveling", "turning", and "stopping" of the vehicle 100. The unmanned driving is implemented by automatic or manual remote control using a device located outside the vehicle 100 or by autonomous control of the vehicle 100. The occupant who does not perform the traveling operation may get on the vehicle 100 that travels via the unmanned driving. Examples of the occupant who does not perform the traveling operation include a person who simply sits on a seat of the vehicle 100 and a person who performs work different from the traveling operation, such as assembly, inspection, or operation of switches, in a state of getting on the vehicle 100. The driving via the traveling operation performed by the occupant may be referred to as "manned driving".

In the present specification, the "remote control" includes "complete remote control" in which all the operations of the vehicle 100 are completely decided from the outside of the vehicle 100, and "partial remote control" in which a part of the operations of the vehicle 100 is decided from the outside of the vehicle 100. In addition, the "autonomous control" includes "complete autonomous control" in which the vehicle 100 autonomously controls the operation thereof without receiving any information from an external device of the vehicle 100, and "partial autonomous control" in which the vehicle 100 autonomously controls the operation thereof by using the information received from the external device of the vehicle 100.

In the present embodiment, the system 50 is used in a factory FC that manufactures the vehicle 100. A reference coordinate system of the factory FC is a global coordinate system GC. That is, any position in the factory FC is represented by coordinates of X, Y, and Z in the global coordinate system GC. The factory FC includes a first place PL1 and a second place PL2. The first place PL1 and the second place PL2 are connected by a track TR on which the vehicle 100 can travel. A plurality of sensors 300 are installed along the track TR in the factory FC. The position of each of the sensors 300 in the factory FC is adjusted in advance. The vehicle 100 moves via the unmanned driving from the first place PL1 to the second place PL2 along the track TR.

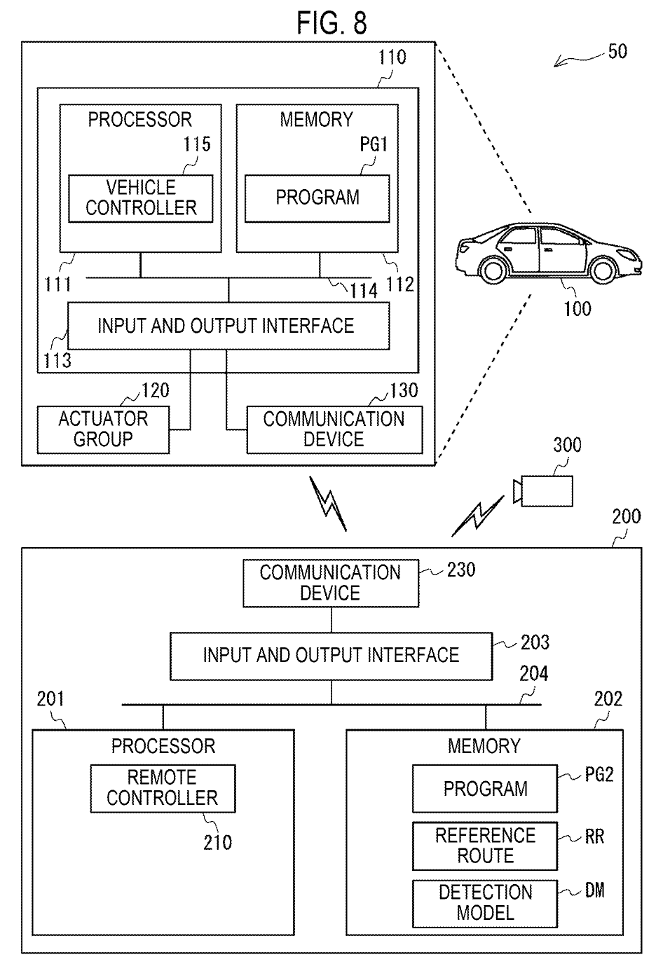

FIG. 8 is a block diagram showing the configuration of the system 50. The vehicle 100 includes a vehicle control device 110 that controls each unit of the vehicle 100, an actuator group 120 including one or more actuators that are driven under control of the vehicle control device 110, and a communication device 130 that communicates with an external device, such as the server 200, via the wireless communication. The actuator group 120 includes an actuator of a drive device for accelerating the vehicle 100, an actuator of a steering device for changing a traveling direction of the vehicle 100, and an actuator of a braking device for decelerating the vehicle 100.

The vehicle control device 110 is configured by a computer including a processor 111, a memory 112, an input and output interface 113, and an internal bus 114. The processor 111, the memory 112, and the input and output interface 113 are connected to be bidirectionally communicable with each other via the internal bus 114. The actuator group 120 and the communication device 130 are connected to the input and output interface 113. The processor 111 executes a program PG1 stored in the memory 112 to realize various functions including a function as the vehicle controller 115.

The vehicle controller 115 controls the actuator group 120 to cause the vehicle 100 to travel. The vehicle controller 115 can cause the vehicle 100 to travel by controlling the actuator group 120 using a traveling control signal received from the server 200. The traveling control signal is a control signal for causing the vehicle 100 to travel. In the present embodiment, the traveling control signal includes the acceleration and a steering angle of the vehicle 100 as parameters. In other embodiments, the traveling control signal may include a speed of the vehicle 100 as the parameter instead of or in addition to the acceleration of the vehicle 100.

The server 200 is configured by a computer including a processor 201, a memory 202, an input and output interface 203, and an internal bus 204. The processor 201, the memory 202, and the input and output interface 203 are connected to be bidirectionally communicable with each other via the internal bus 204. A communication device 230 for communicating with various devices outside the server 200 is connected to the input and output interface 203. The communication device 230 can communicate with the vehicle 100 via wireless communication, and can communicate with each of the external sensors 300 via wired communication or wireless communication. The processor 201 executes a PG2 stored in the memory 202 to realize various functions including a function as a remote controller 210.

The remote controller 210 acquires a detection result of the sensor and can generate the traveling control signal for controlling the actuator group 120 of the vehicle 100 using the detection result. The remote controller 210 causes the vehicle 100 to travel by remote control by transmitting the traveling control signal to the vehicle 100. The remote controller 210 may generate, for example, a control signal for controlling various accessories provided in the vehicle 100 or actuators for operating various kinds of equipment, such as a wiper, a power window, or a lamp, in addition to the traveling control signal, and output the generated control signal. That is, the remote controller 210 may operate the various kinds of equipment or the various accessories via the remote control.

The external sensor 300 is a sensor located outside the vehicle 100. The external sensor 300 according to the present embodiment is a sensor that captures the vehicle 100 from the outside of the vehicle 100. The external sensor 300 includes a communication device (not shown), and can communicate with other devices, such as the server 200, via wired communication or wireless communication.

Specifically, the sensor 300 is configured by a camera. The camera as the external sensor 300 captures a captured image including the vehicle 100 and outputs the captured image as a detection result.

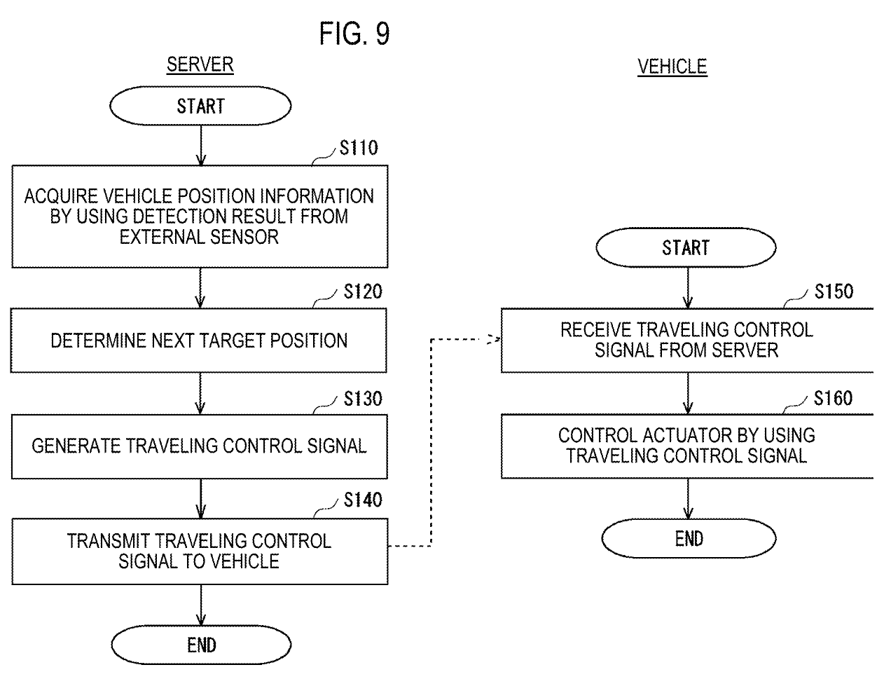

FIG. 9 is a flowchart showing a processing procedure of the traveling control of the vehicle 100 in the traveling control example. In the processing procedure of FIG. 9, the processor 201 of the server 200 executes the program PG2 to function as the remote controller 210. In addition, the processor 111 of the vehicle 100 executes the program PG1 to function as the vehicle controller 115.

In S110, the processor 201 of the server 200 acquires vehicle position information of the vehicle 100 by using the detection result output from the sensor 300. The vehicle position information is position information that is a basis for generating the traveling control signal. In the present embodiment, the vehicle position information includes the position and the direction of the vehicle 100 in the global coordinate system GC of the factory FC. Specifically, in S110, the processor 201 acquires the vehicle position information by using the captured image acquired from the camera that is the sensor 300.

Specifically, in S110, the processor 201 detects, for example, an outer shape of the vehicle 100 from the captured image and calculates coordinates of a positioning point of the vehicle 100 in a coordinate system of the captured image, that is, a local coordinate system. The processor 201 acquires the position of the vehicle 100 by converting the calculated coordinates into coordinates in the global coordinate system GC. The outer shape of the vehicle 100 included in the captured image can be detected, for example, by inputting the captured image to a detection model using artificial intelligence. The detection model DM is prepared, for example, inside the system 50 or outside the system 50, and is stored in advance in the memory 202 of the server 200. Examples of the detection model DM include a trained machine learning model that has been trained to implement any one of semantic segmentation and instance segmentation. As the machine learning model, for example, a convolutional neural network (CNN) that has been trained by supervised learning using a training data set can be used. The training data set has, for example, a plurality of training images including the vehicle 100 and a label indicating whether each area in the training image is an area indicating the vehicle 100 or an area indicating an area other than the vehicle 100. When the CNN is trained, it is preferable that parameters of the CNN are updated such that an error between an output result of the detection model DM and the label is reduced by backpropagation (error backpropagation method). The processor 201 can acquire the direction of the vehicle 100 by performing the estimation based on a direction of a movement vector of the vehicle 100 calculated from a positional change in a feature point of the vehicle 100 between frames of the captured image by using, for example, an optical flow method.

In S120, the processor 201 of the server 200 determines a target position to which the vehicle 100 is to travel next. In the present embodiment, the target position is represented by the coordinates of X, Y, and Z in the global coordinate system GC. The reference route RR that is a route along which the vehicle 100 should travel is stored in advance in the memory 202 of the server 200. The route is represented by a node indicating a departure point, a node indicating a passing point, a node indicating a destination, and a link connecting the respective nodes. The processor 201 decides the target position to which the vehicle 100 should head next by using the vehicle position information and the reference route RR. The processor 201 decides the target position on the reference route RR ahead of the current position of the vehicle 100.

In step S130, the processor 201 of the server 200 generates the traveling control signal for causing the vehicle 100 to travel toward the decided target position. The processor 201 calculates the traveling speed of the vehicle 100 from the transition of the position of the vehicle 100, and compares the calculated traveling speed with a target speed. As a whole, the processor 201 decides the acceleration such that the vehicle 100 is accelerated when the traveling speed is lower than the target speed, and decides the acceleration such that the vehicle 100 is decelerated when the traveling speed is higher than the target speed. In addition, the processor 201 determines the steering angle and the acceleration such that the vehicle 100 does not deviate from the reference route RR in a case where the vehicle 100 is positioned on the reference route RR. In a case where the vehicle 100 is not located on the reference route RR, in other words, in a case where the vehicle 100 deviates from the reference route RR, the processor 201 decides the steering angle and the acceleration such that the vehicle 100 returns to the reference route RR.

In S140, the processor 201 of the server 200 transmits the generated traveling control signal to the vehicle 100. The processor 201 repeatedly executes, at a predetermined cycle, the acquisition of the position of the vehicle 100, the decision of the target position, the generation of the traveling control signal, and the transmission of the traveling control signal.

In S150, the processor 111 of the vehicle 100 receives the traveling control signal transmitted from the server 200. In step S160, the processor 111 of the vehicle 100 controls the actuator group 120 by using the received traveling control signal, to cause the vehicle 100 to travel at the acceleration and the steering angle represented by the traveling control signal. The processor 111 repeatedly executes, at a predetermined cycle, the reception of the traveling control signal and control of the actuator group 120. With the system 50 according to the present embodiment, the vehicle 100 can be caused to travel by the remote control, and the vehicle 100 can move without using a transport facility, such as a crane or a conveyor.

### B: Traveling Control Example 2

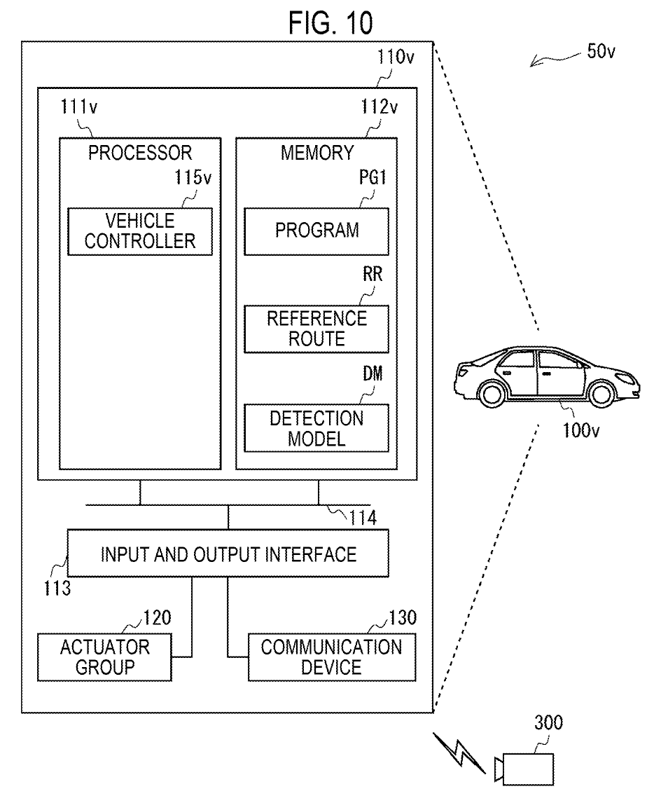

FIG. 10 is an explanatory diagram showing a schematic configuration of a system 50v in the traveling control example 2. In the present example, the system 50v is different from the traveling control example 1 in that the system 50v does not include the server 200. In addition, the vehicle 100v in the configuration can travel by autonomous control of the vehicle 100v. The other configurations are the same as those described above unless otherwise specified.

In the present example, the processor 111v of the vehicle control device 110v functions as the vehicle controller 115v by executing the program PG1 stored in the memory 112v. The vehicle controller 115v can acquire the output result of the sensor, generate the traveling control signal by using the output result, and output the generated traveling control signal to operate the actuator group 120, thereby causing the vehicle 100v to travel via the autonomous control. In the present example, the detection model DM and the reference route RR are stored in the memory 112v in addition to the program PG1.

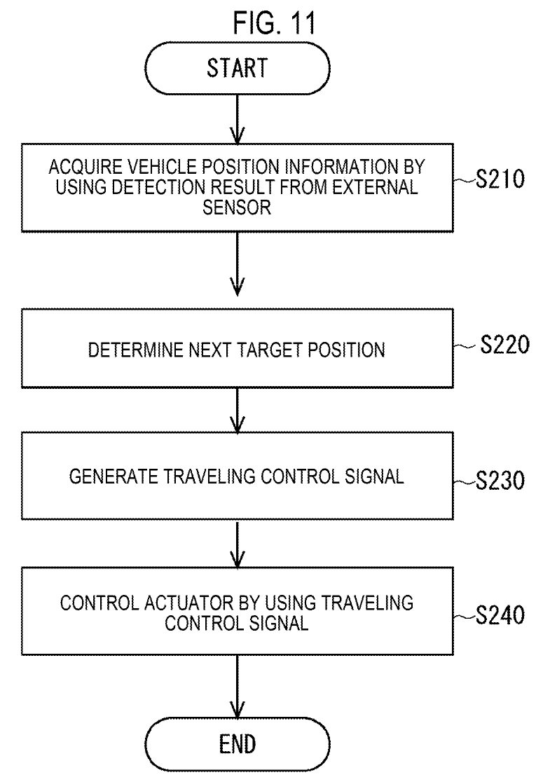

FIG. 11 is a flowchart showing a processing procedure of the traveling control of the vehicle 100v in Example 2. In the processing procedure of FIG. 11, the processor 111v of the vehicle 100v executes the program PG1 to function as the vehicle controller 115v.

In S210, the processor 111v of the vehicle control device 110v acquires the vehicle position information by using the detection result output from the camera that is the sensor 300. In S220, the processor 111v determines a target position to which the vehicle 100v is to travel next. In step S230, the processor 111v generates the traveling control signal for causing the vehicle 100v to travel toward the decided target position. In step S240, the processor 111v controls the actuator group 120 by using the generated traveling control signal, to cause the vehicle 100v to travel in accordance with the parameters represented by the traveling control signal. The processor 111v repeatedly executes, at a predetermined cycle, the acquisition of the vehicle position information, the decision of the target position, the generation of the traveling control signal, and the control of the actuator. With the system 50v according to the present embodiment, the vehicle 100v can be caused to travel via the autonomous control of the vehicle 100v without the need for the server 200 to remotely control the vehicle 100v.

### YY: Other Traveling Control Examples

(YY1) In the above example, the sensor 300 is a camera. On the other hand, the sensor 300 may not be a camera and may be, for example, light detection and ranging (LiDAR). In this case, the detection result output by the external sensor 300 may be three-dimensional point cloud data representing the vehicle 100. In this case, the server 200 or the vehicle 100 may acquire the vehicle position information via template matching using the three-dimensional point cloud data as the detection result, and reference point cloud data prepared in advance.

(YY2) In the traveling control example 1, the server 200 executes processing from the acquisition of the vehicle position information to the generation of the traveling control signal. On the other hand, the vehicle 100 may execute at least a part of the processing from the acquisition of the vehicle position information to the generation of the traveling control signal. For example, the following forms (1) to (3) may be used.
(1) The server 200 may acquire the vehicle position information, decide the target position to which the vehicle 100 should head next, and generate the route from the current position of the vehicle 100 represented by the acquired vehicle position information to the target position. The server 200 may generate a route to the target position between the current position and the destination or may generate a route to the destination. The server 200 may transmit the generated route to the vehicle 100. The vehicle 100 may generate the traveling control signal for causing the vehicle 100 to travel on the route received from the server 200, and control the actuator group 120 by using the generated traveling control signal.
(2) The server 200 may acquire the vehicle position information and transmit the acquired vehicle position information to the vehicle 100. The vehicle 100 may decide the target position to which the vehicle 100 should head next, generate the route from the current position of the vehicle 100 represented by the received vehicle position information to the target position, generate the traveling control signal such that the vehicle 100 travels on the generated route, and control the actuator group 120 by using the generated traveling control signal.
(3) In each of the above-described forms (1) and (2), an internal sensor may be mounted on the vehicle 100, and a detection result output from the internal sensor may be used for at least one of the generation of the route and the generation of the traveling control signal. The internal sensor is a sensor mounted in the vehicle 100. The internal sensor may include, for example, a sensor that detects a motion state of the vehicle 100, a sensor that detects an operation state of each unit of the vehicle 100, or a sensor that detects a surrounding environment of the vehicle 100. Specifically, the internal sensor may include, for example, a camera, a LiDAR, a millimeter wave radar, an ultrasound sensor, a GPS sensor, an acceleration sensor, and a gyro sensor. For example, in the above-described form (1), the server 200 may acquire the detection result of the internal sensor and reflect the detection result of the internal sensor in the route when the route is generated. In the above-described form (1), the vehicle 100 may acquire the detection result of the internal sensor and reflect the detection result of the internal sensor to the traveling control signal when the traveling control signal is generated. In the above-described form (2), the vehicle 100 may acquire the detection result of the internal sensor and reflect the detection result of the internal sensor to the route when the route is generated. In the above-described form (2), the vehicle 100 may acquire the detection result of the internal sensor and reflect the detection result of the internal sensor to the traveling control signal when the traveling control signal is generated.

(YY3) In the traveling control example 2, an internal sensor may be mounted on the vehicle 100v, and the detection result output from the internal sensor may be used for at least one of the generation of the route or the generation of the traveling control signal. For example, the vehicle 100v may acquire the detection result of the internal sensor and reflect the detection result of the internal sensor to the route when the route is generated. The vehicle 100v may acquire the detection result of the internal sensor and reflect the detection result of the internal sensor to the traveling control signal when the traveling control signal is generated.

(YY4) In the traveling control example 2, the vehicle 100v acquires the vehicle position information by using the detection result of the sensor 300. On the other hand, the vehicle 100v is equipped with the internal sensor. The vehicle 100v may acquire the vehicle position information by using the detection result of the internal sensor and determine the target position to which the vehicle 100v is to travel next. The vehicle 100v may generate a route from the current location of the vehicle 100v represented by the acquired vehicle position information to the target position, and generate the traveling control signal for traveling on the generated route. The vehicle 100v may control the actuator group 120 by using the generated traveling control signal. In this case, the vehicle 100v can travel without using the detection result of the external sensor 300 at all. The vehicle 100v may acquire a target arrival time or traffic jam information from the outside of the vehicle 100v and reflect the target arrival time or the traffic jam information to at least one of the route and the traveling control signal. In addition, all of the functions of the system 50v may be provided in the vehicle 100v. That is, the processing implemented by the system 50v according to the present disclosure may be implemented by the vehicle 100v alone. For example, the head vehicle 100v may transmit the control instruction value to the subsequent vehicle 100.

(YY5) In the traveling control example 1, the server 200 automatically generates the traveling control signal to be transmitted to the vehicle 100. On the other hand, the server 200 may generate the traveling control signal to be transmitted to the vehicle 100 in response to an operation of an external operator who is located outside the vehicle 100. For example, the external operator operates a control device including a display that displays the captured image output from the sensor 300, a steering wheel for remotely operating the vehicle 100, an accelerator pedal, a brake pedal, and a communication device for communicating with the server 200 by wired communication or wireless communication. The server 200 may generate the traveling control signal in accordance with the operation applied to the control device.

(YY6) In each of the traveling control examples, the vehicle 100 may have a configuration that can move by unmanned driving, and may have, for example, a form of a platform including a configuration described below. Specifically, the vehicle 100 need solely include at least the vehicle control device 110 and the actuator group 120, in order to exhibit the three functions of "traveling", "turning", and "stopping" via the unmanned driving. In a case where the vehicle 100 acquires the information from the outside for the unmanned driving, the vehicle 100 need solely further include the communication device 130. That is, the vehicle 100 that can move via the unmanned driving need not be equipped with at least a part of interior components, such as a driver's seat and a dashboard. The vehicle 100 need not be equipped with at least a part of exterior components, such as a bumper or a fender, and need not be equipped with the body shell. In this case, the vehicle 100 may be equipped with the remaining components, such as the body shell, before the vehicle 100 is shipped from the factory FC. The vehicle 100 may be equipped with the remaining components, such as the body shell, after the vehicle 100 is shipped from the factory FC in a state where the vehicle 100 is not equipped with the remaining components, such as the body shell. Each component may be mounted from any direction, such as the upper side, the lower side, the front side, the rear side, the right side, or the left side of the vehicle 100, and may be mounted from the same direction or different directions. The position decision can be made for the form of the platform in the same manner as the vehicle 100 according to the first embodiment.

(YY7) The vehicle 100 may be manufactured by combining a plurality of modules. The module means a unit configured by a plurality of components assembled depending on the part or the function of the vehicle 100. For example, the platform of the vehicle 100 may be manufactured by combining a front module that constitutes a front portion of the platform, a center module that constitutes a center portion of the platform, and a rear module that constitutes a rear portion of the platform. In addition, the number of modules constituting the platform is not limited to three, and may be two or less or four or more. In addition to or instead of the components constituting the platform, the components constituting a portion of the vehicle 100 that is different from the platform may be modularized. In addition, various modules may include any exterior component, such as a bumper or a grille, or any interior component, such as a seat or a console. The present disclosure is not limited to the vehicle 100, a moving object of any aspect may be manufactured by combining the modules. Such a module may be manufactured, for example, by joining the components via welding, a fastener, or the like, or may be manufactured by integrally molding at least a part of the components constituting the modules as one component via casting. A molding method of integrally molding one component, particularly a relatively large component, is also called giga casting or mega casting. For example, the front module, the center module, and the rear module may be manufactured by using giga casting.

(YY8) The transport of the vehicle 100 using the traveling of the vehicle 100 via the unmanned driving is also referred to as "autonomous driving transport". A configuration for implementing the autonomous driving transport is also referred to as "vehicle remote control autonomous driving transport system". A production method of producing the vehicle 100 by using the autonomous driving transport is also referred to as "autonomous driving production". In the autonomous driving production, for example, at the factory FC that manufactures the vehicle 100, at least a part of the transport of the vehicle 100 is implemented by the autonomous driving transport.

(YY9) In each of the traveling control examples, a part or all of functions and processing implemented by software may be implemented by hardware. Alternatively, a part or all of the functions and the processing that are implemented by hardware may be implemented by software. As the hardware for implementing various functions in each of the above-described embodiments, for example, various circuits, such as an integrated circuit or a discrete circuit, may be used.

In the traveling control examples 1 and 2, the traveling control shown in FIGS. 1 to 6 and the like can be applied. As a result, the subsequent vehicle can bypass the abnormal vehicle.

In addition, a part or all of the processing in the vehicle 100, the server 200, the sensor 300, the robot 600, and the like described above can be implemented as a computer program. Such a program can be stored in various types of non-transitory computer-readable media and supplied to a computer. The non-transitory computer-readable medium includes various types of tangible recording media. Examples of the non-transitory computer-readable medium include a magnetic recording medium (for example, a flexible disk, a magnetic tape, and a hard disk drive), a magneto-optical recording medium (for example, a magneto-optical disk), a read-only memory (ROM), a compact disc (CD)-ROM, a CD-R, a CD-R/W, and a semiconductor memory (for example, a mask ROM, a programmable ROM (PROM), an erasable PROM (EPROM), a flash ROM, and a random access memory (RAM)). In addition, the program may be supplied to the computer by various types of temporary computer-readable media. Examples of the transitory computer readable media include electrical signals, optical signals, and electromagnetic waves. The transitory computer readable medium can supply the program to the computer via a wired communication path such as an electric wire and an optical fiber, or a wireless communication path.

The present disclosure is not limited to the embodiment, and can be appropriately modified without departing from the spirit.

What is claimed is:

1. A vehicle manufacturing system that controls, during a manufacturing process or during a transport process, a plurality of vehicles such that the vehicles travel in a formation, wherein the vehicle manufacturing system is configured to
detect, among the vehicles, an abnormal vehicle in which an abnormality has occurred,
stop the abnormal vehicle, and
cause a subsequent vehicle that travels behind the abnormal vehicle to travel such that the subsequent vehicle bypasses the abnormal vehicle that is not moving.

2. The vehicle manufacturing system according to claim 1, wherein, in a case where the vehicles are moving along a movement route, the vehicle manufacturing system is configured to
stop the abnormal vehicle after the abnormal vehicle retreats to be deviated from the movement route in a left-right direction, and
cause the subsequent vehicle to travel such that the subsequent vehicle bypasses the abnormal vehicle to a side opposite to a retreat direction in the left-right direction, the retreat direction being a direction in which the abnormal vehicle has retreated.

3. The vehicle manufacturing system according to claim 2, wherein the vehicle manufacturing system is configured to
set a bypass route that bypasses the abnormal vehicle and then merges with the movement route, and
control the subsequent vehicle such that the subsequent vehicle travels along the bypass route.

4. The vehicle manufacturing system according to claim 2, wherein the vehicle manufacturing system is configured to switch the subsequent vehicle to autonomous driving such that the subsequent vehicle bypasses the abnormal vehicle.

5. A vehicle manufacturing method of controlling, during a manufacturing process or during a transport process, a plurality of vehicles such that the vehicles travel in a formation, the vehicle manufacturing method comprising:
detecting, among the vehicles, an abnormal vehicle in which an abnormality has occurred;
stopping the abnormal vehicle; and
causing a subsequent vehicle that travels behind the abnormal vehicle to travel such that the subsequent vehicle bypasses the abnormal vehicle that is not moving.
